(19) United States
(12) Patent Application Publication
(10) Pub. No.: US 2018/0225367 A1
(43) Pub. Date: Aug. 9, 2018

(54) System and Method for Activity Classification

(71) Applicant: Under Armour, Inc., Baltimore, MD (US)

(72) Inventors: Allan Glen, Denver, CO (US); Ben Hamill, Austin, TX (US); Christopher Peters, Austin, TX (US); Eric Roberts, Austin, TX (US); Brett Nekolny, Denver, CO (US); Amy Troschinetz, Austin, TX (US)

(21) Appl. No.: 15/426,562

(22) Filed: Feb. 7, 2017

(51) Int. Cl. G06F 17/30; G06N 99/00

(52) U.S. Cl. CPC G06F 17/30705; G06F 17/30722; G06N 99/005

(57) ABSTRACT

System and method for automatically associating metadata tags to one or more activities; enabling user association of metadata tags to one or more activities; and associating non-activities to logged activities. In one embodiment, the method comprises: receiving text descriptions relating to activities; using at least one machine learning technique to automatically identify one or more aspects and a corresponding one or more characteristic from a library; creating a metadata tag comprising the aspects and characteristics; and associating the metadata tags to the text descriptions to which it relates. Each of the aspects in the library is associated to a unique subset of possible characteristics. Each of the text descriptions may be included in a schedule and a metabolic equivalent of task (MET) score for each may be calculated.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to the field of activity classification via utilization of metadata tags, the metadata tags include one or more aspect identifiers and associated characteristics descriptive thereof. More particularly, the present disclosure relates to systems, computer programs, devices, and methods for: (i) automatically associating metadata tags to one or more activities; (ii) enabling user association of metadata tags to one or more activities; and (iii) associating non-activities to logged activities.

### BACKGROUND

In recent years, health monitoring devices that are used or worn by users to measure or track physical and physiological information relating to the health and activity levels of the users have gained great popularity. Such health monitoring devices collect health data relating to a user, including exercise data, and enable the data to be stored, processed, and displayed to the user. In one embodiment, the health monitoring devices comprise computing devices, such as smartphones or personal computers, which are configured to execute one or more software programs for analysis of the data. Common health data analysis systems provide displays of information relating to the user's health goals, diet advice or analysis, and exercise advice or analysis, etc. based on the collected health data. Specifically, a health data analysis system may maintain a record of and display a user's activity log over a period of time.

Given the rapid advances in the field of health monitoring, many users upgrade to newer health monitoring devices and/or utilize different software applications for tracking health data over comparatively short time periods. Receiving and/or analyzing data from different hardware devices often produces inaccurate analytical results specifically when labels or identifiers for particular health-related parameters differ across the applications and/or devices. Consequently, improvements to analysis systems are needed.

### SUMMARY

The present disclosure addresses the foregoing needs by disclosing, inter alia, methods, devices, systems, and computer programs for associating metadata tags to one or more activities, the metadata tags include one or more aspect identifiers and associated characteristics descriptive thereof.

In one aspect of the disclosure, a method of automating categorization of activities is provided. In one embodiment, the method comprises: (i) receiving at a network server one or more text descriptions relating to a respective one or more activities; (ii) the network server using at least one machine learning technique to, for each of the plurality of text descriptions, automatically identify one or more of a plurality of aspects and a corresponding particular one of a plurality of characteristics further descriptive of each of the one or more identified aspects from a library thereof applicable thereto; (iii) for each of the plurality of text descriptions, creating a metadata tag comprising the one or more of the plurality of aspects and the corresponding particular one of the plurality of characteristics; and (iv) associating respective ones of the metadata tags to each of the plurality of text descriptions to which it relates. Each of the plurality of aspects in the library is associated to a unique subset of the plurality of characteristics, the particular one of the plurality of characteristics for each of the one or more of the plurality of aspects being selected from the unique subset associated thereto.

In another aspect of the disclosure, a non-transitory, computer readable medium is provided. In one embodiment, the computer readable medium comprises a plurality of instructions which are configured to, when executed, cause a user device to: (i) access a library comprising a plurality of aspects and a corresponding plurality of characteristics further descriptive of each of the plurality of aspects; (ii) select one or more of the plurality of aspects and a respective one or more of the plurality of characteristics to create a metadata tag representative of one or more activities; (iii) calculate a metabolic equivalent of task (MET) score based on the metadata tag(s) relating to the one or more activities; and (iv) create a workout log relating to the one or more activities, the log comprising at least the calculated MET score.

In yet another aspect of the disclosure, a network apparatus configured to enable automated categorization of activities is provided. In one embodiment, the apparatus comprises: one or more interfaces; a storage apparatus; and a processor configured to execute at least one computer application thereon, the computer application comprising a plurality of instructions which are configured to, when executed, cause the network apparatus to: (i) use at least one machine learning technique to, for each of a plurality of entered text descriptions relating to one or more activities, automatically identify one or more of a plurality of aspects and a corresponding particular one of a plurality of characteristics further descriptive of each of the one or more identified aspects from a library thereof applicable thereto; (ii) for each of the plurality of text descriptions, create a metadata tag comprising the one or more of the plurality of aspects and the corresponding particular one of the plurality of characteristics; (iii) associate respective ones of the metadata tags to each of the plurality of text descriptions to which it relates; and (iv) calculate a metabolic equivalent of task (MET) score based on the metadata tags for each of the plurality of text descriptions.

These and other aspects of the disclosure shall become apparent when considered in light of the disclosure provided herein.

### BRIEF DESCRIPTION OF THE DRAWINGS

FIG. 1 is a block diagram illustrating an exemplary system for associating metadata tags to one or more activities in accordance with one embodiment of the present disclosure.

FIG. 2A is an exemplary table of aspects and associated characteristics for each to be utilized to generate a metadata tag in accordance with one embodiment of the present disclosure.

FIG. 2B is a graphic representation illustrating application of one or more score calculation rules in accordance with one embodiment of the present disclosure.

FIG. 2C is a graphic representation illustrating application of metadata tags to non-activities in accordance with one embodiment of the present disclosure.

FIG. 3 is a logical flow diagram illustrating an exemplary method for automatically associating metadata tags to one or more activities in accordance with one embodiment of the present disclosure.

FIG. 4 is a logical flow diagram illustrating an exemplary method for enabling user association of metadata tags to one or more activities in accordance with one embodiment of the present disclosure.

FIG. 5 is a logical flow diagram illustrating another exemplary method for automatically associating metadata tags to one or more activities in accordance with one embodiment of the present disclosure.

FIG. 6 is a logical flow diagram illustrating an exemplary method for associating non-activities to logged activities in accordance with one embodiment of the present disclosure.

FIG. 7 is a block diagram illustrating an exemplary user device in accordance with one embodiment of the present disclosure.

FIG. 8 is a block diagram illustrating an exemplary server apparatus in accordance with one embodiment of the present disclosure.

All Figures © Under Armour, Inc. 2016. All rights reserved.

### DETAILED DESCRIPTION

Disclosed embodiments include systems, apparatus, methods and storage media which (i) automatically associate metadata tags to one or more activities; (ii) enable user association of metadata tags to one or more activities; and (iii) associate non-activities to logged activities.

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Similar logic applies to the use of the term “or” herein; i.e., “A or B” means (A), (B), or (A and B).

The terms “comprising,” “including,” “having,” and the like, as used with respect to embodiments of the present disclosure, are synonymous.

Network Architecture

There exists a persistent need to enable association of metadata tags to one or more activities in order to provide a standardized mechanism for labeling thereof. It is further advantageous to enable user association of metadata tags to one or more activities; and/or to associate non-activities to logged activities in order to provide recommendations. The present disclosure provides a system, methods and apparatus specifically configured to provide the foregoing functionality.

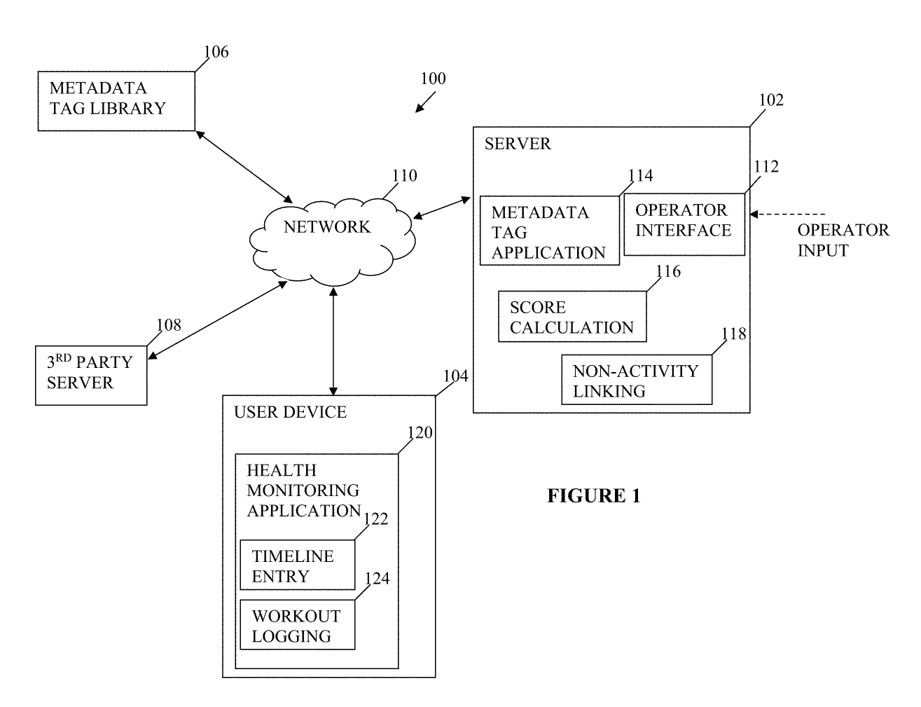

Referring now to FIG. 1, an exemplary system enabling association of metadata tags to one or more activities is shown. As illustrated, the system generally comprises a server apparatus 102 in communication with one or more user devices 104, a metadata tag library 106, and a third party server 108 via a network 110.

The network 110 which enables communication between the server 102, the plurality of user devices 104, the metadata library 106, and the third party server 108 (each discussed in turn below) may comprise one or more wired and/or wireless, private and/or public network, including but not limited to, e.g., the Internet. The network 110 is, for example, a wireless local area network (WLAN), wireless wide area network (WWAN), wired network, or any other suitable communication channel. Accordingly, each of the user devices 104, server(s) 102, metadata library 106, and third party server 108 are configured with appropriate networking communication interfaces. An example of wired communication interface may include, but is not limited to, Ethernet; while examples of wireless communication interfaces may include, but are not limited to, near field communication (NFC), Bluetooth, Wi-Fi, 4G or 5G LTE. It is further appreciated that various gateways, routers, switches, base stations, and so forth may be involved in facilitating and forwarding communication between the foregoing devices. Additionally, it is noted that the foregoing network may comprise several networks, such that the described components are distributed in various ones thereof. In alternative embodiments, the network may comprise a series of devices communicating within software via software API's.

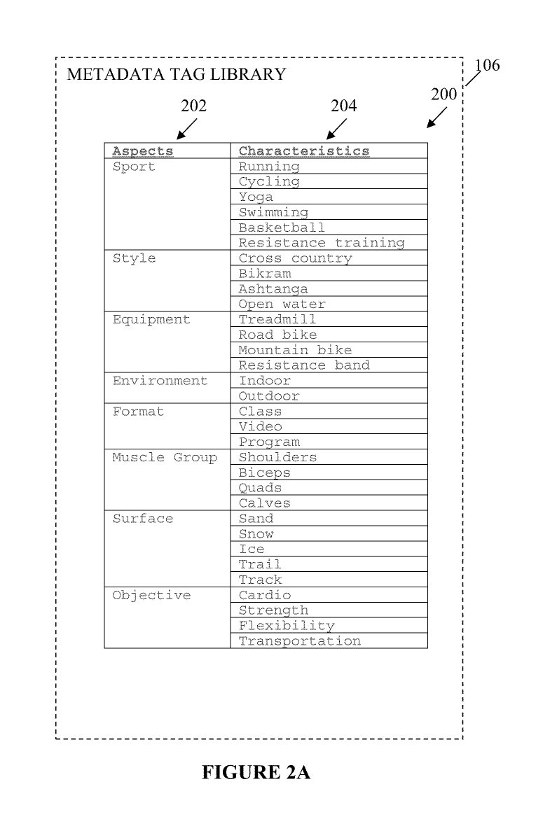

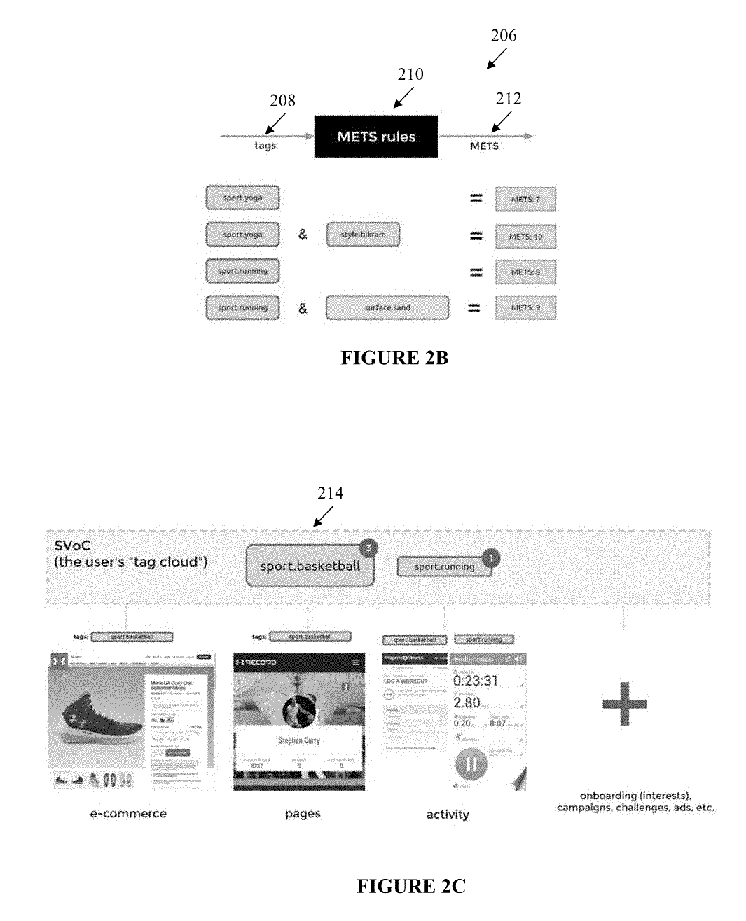

The metadata tag library 106 comprises a database or store of records relating to uniform activity descriptions including e.g., aspects and associated characteristics. An exemplary table 200 demonstrating exemplary aspects 202 and their associated characteristics 204 is illustrated at FIG. 2A. Selection of one or more aspects and associated characteristics are utilized to form a metadata tag as will be discussed in greater detail below. It is further appreciated that the examples given in FIG. 2A are merely illustrative of the general concepts provided herein; other aspects and/or characterizations may be utilized with equal success.

It is appreciated that in the illustrated embodiment, the metadata tag library 106 comprises a separate entity in communication with the network server 102, the third party server 108, and the user device(s) 104. However, in other variants, the metadata tag library 106 may be provided in part or in whole to the user device 104 for storage thereat. For example, components which are specific to a particular type of device and/or particular health monitoring applications are provided only to those devices 104 as needed. Additionally, or in the alternative, the metadata library 106 may be stored at the server 102 and portions thereof may be made accessible to particular devices 104. Any combination of the foregoing configurations may be utilized with equal success.

The user devices 104, in one exemplary implementation, comprise one or more portable computerized devices which are configured to measure, obtain, monitor, generate, collect, sense, or otherwise receive biometric, environmental, activity and/or health parameters. User devices 104 may also be referred to herein as health and/or activity monitoring devices, or client devices. In one variant, certain ones of the user devices 104 comprise wearable health-related parameter measurement and computing devices, such as e.g., a smart watch, a chest strap, an activity tracker, a heart rate monitor, a sleep tracking device, a nutrition tracking device, a foot pod or other sensor placed in an article of clothing, a smart scale, and/or smart eyeglasses. In addition, an exemplary user device 104 may comprise a smartphone having one or more of the foregoing capabilities and/or which enables user entry of the foregoing health data. Alternatively, the user device 104 is in communication with a separate health and/or activity monitoring device to receive health and/or activity data therefrom.

The sensed health parameter data comprises data which the particular device 104 is configured to collect (such as activity, biometric, and/or environmental data). For example, an activity tracking device is configured to collect activity data such as steps taken, distance travelled, rate or pace of a run, and/or flights of stairs climbed, etc.; a heart rate monitor is configured to collect heartbeat data; a sleep tracking device collects data relating to how much time a user/wearer spends sleeping; a nutrition tracking device collects data relating to food and drinks consumed by a user; a smart scale collects data relating to a body weight, body fat percentage, and/or body mass index (BMI), etc. Furthermore, a smartwatch and/or smartphone, may be utilized as an activity tracking device, a heart rate monitor, a sleep tracking device, and/or a nutrition tracking device. The user device 104 may comprise any of the foregoing types of devices and/or may receive collected data from a first device at one or more applications running on the user device 104.

As shown, the exemplary user device is further configured to run at least one health monitoring application 120 thereon. The health monitoring application 120 comprises a software application configured to enable entry or logging of health related data (including activity, sleep, and/or nutrition data) for display. Exemplary health monitoring applications 120 include e.g., UA Record™, MapMyFitness®, MyFitnessPal®, Endomondo®, etc. each owned by assignee hereof. Other health activity related monitoring applications 120 may additionally be utilized in connection with the present disclosure, such as those specifically designed to receive information from a particular type of health monitoring device (i.e., an application which is published by the device manufacturer); the foregoing being merely representative of the general concepts of the present disclosure.

As will be discussed in greater detail below, in one exemplary embodiment the health monitoring application 120 running at the user device 104 is configured to at least comprise a set of instructions for generating a timeline entry 122 and a set of instructions for logging a workout 124. As will be discussed in further detail elsewhere herein, the instructions for generating a timeline entry 122 are configured to receive information relating to a user's participation in a given activity and generate a social media post relating thereto. The timeline entry application 122 may receive information used to create the social media post from the health monitoring application 120, the metadata tag application 114 (and/or a similar application located at the user device (not shown)), and/or the score calculation application 116 (and/or a similar application located at the user device (not shown)). Also discussed below, the instructions for logging a workout 124 are specifically configured to receive information relating to a user's participation in a given activity including an estimated amount of calories burned therefrom and generate a workout summary which may be held privately for the user. In one variant, the workout log instructions 124 are configured to indicate a number of calories burned versus an estimated amount of calorie intake. In yet another embodiment, the workout log may be made public upon user selection. The workout log application 124 may receive information used to create the workout record from the health monitoring application 120, the metadata tag application 114 (and/or a similar application located at the user device (not shown)), and/or the score calculation application 116 (and/or a similar application located at the user device (not shown)).

The server 102 as illustrated in FIG. 1 comprises one or more computerized devices operable to enable application of metadata tags to activities so as to create uniformity in the way these are labelled. To this end, as shown, the exemplary server 102 comprises at least an operator interface 112, a metadata tag application 114, a score calculation application 116, and a non-activity linking application 118. Additional features and components of the server 102 will be discussed in further detail below.

The metadata tag application 114, as discussed elsewhere herein, enables specific tags from the metadata tag library 106 to be applied to activities. The metadata tags are comprised of at least one first level descriptor, referred to herein as an “aspect” and at least one second level descriptor, referred to herein as a “characteristic”. The characteristics further qualify one or more facets of the aspect to which each relates. As illustrated in FIG. 2A, the metadata tag library 106 comprises a store of records 200 which are used to create metadata tags, the records 200 include a plurality of aspects 202 and, for each aspect(s), a plurality of characteristics 204. An exemplary metadata tag for a treadmill run may comprise, for example, “sport.running equipment.treadmill”; as shown, the metadata tag describes the first aspect (sport) as running and then further defines the second aspect to have the characteristic of equipment, in this case specifically a treadmill. Additional examples are provided in Table 1 below, it is noted that the herein listed examples are provided to demonstrate the general concepts of the present disclosure and are not limiting in nature.

TABLE 1

| Common Name | Exemplary Metadata Tag |
|---|---|
| Trail Run | sport.running surface.trail |
| Dog Run | sport.running companion.dog |
| Bicep curls | sport.resistance_training equipment.dumbbells |
| | muscle_group.biceps body_region.arms |
| | muscle_mechanics_type.isolation |
| Basketball | sport.basketball |
| Basketball practice | sport.basketball objective.practice |
| Treadmill Walk | sport.walking equipment.treadmill |
| Dog Walk | sport.walking companion.dog |

In this manner, activities may be provided with uniform tags. Moreover, as discussed in greater detail below, the activity may be scored (such as via MET scores) based on the uniform tags, thereby causing the activity scores to be uniform and/or more accurate.

In one embodiment, the metadata tag application 114 is configured to automatically associate metadata tags to one or more activities. According to this embodiment, text descriptions of the activities may be entered manually, via spoken word, and/or via selection from a list of available activities. In one variant, the user of the user device 104 may enter the text descriptions of the activities via an interface or screen of the health monitoring application 120 running thereon. The user may do so in anticipation of or following participation in the activity. The metadata tag application 114 matches one or more individual words of the text descriptions to various aspect and/or characteristic records in the metadata tag database 106. Matching may occur via utilization of one or more machine learning techniques. In another variant, an operator associated to an activity provider may upload the text descriptions to the third party server 108 via a computerized apparatus in communication therewith. Similarly, the individual words of these descriptions are matched via the metadata tag application 114 to aspects and/or characteristics in the database 106, in some instances via machine learning. The activity provider may comprise a gym, studio, sports team, etc., and may post the activities in the form of a schedule for e.g., upcoming events and classes. The user of the user device 104 may later select one or more activities from the uploaded activities which he/she has participated in or intends to participate in.

In another embodiment, the metadata tag application 114 is configured to enable user association of metadata tags to one or more activities. According to this embodiment, the user and/or the activity provider is able to select appropriate activity descriptions from the metadata tag library 106 which are appropriate to the activities of interest (as opposed to the selection occurring automatically as discussed above). The user, activity provider, or other operator may review a list of available aspects for selection, once selected, a corresponding list of available characteristics is provided which corresponds to the selected aspect. The user, activity provider and/or operator may select any number of aspects and/or characteristics.

The score calculation application 116 is configured to calculate a score which estimates or represents energy expenditure due to participation in an activity. In the flow diagram 206 of FIG. 2B, a score is applied using a plurality of rules. The calculated score is based on a set of rules which relate each metadata tag to a corresponding metabolic equivalent of task (MET) score. However it is appreciated that alternative scoring systems may be used with equal success. In this manner, scoring is made accurate and uniform across all activity types.

In the embodiment illustrated at FIG. 2B, each aspect and associated characteristic in the metadata tag library 106 is associated to a particular MET score. Hence, the tags 208 are entered into a rules engine 210 and a resultant score 212 is provided. In the illustrated examples, an entry for yoga having the metadata tag “sport.yoga” is given a MET score of 7; whereas the metadata tag “sport.yoga style.bikram” is given a MET score of 10. As shown, the entry for “sport.running” is given a MET score of 8; whereas the “sport.running surface.sand” entry is given a MET score of 9.

In some instances the MET score may not be affected by a given characteristic. For example, a MET score for the metadata tag “sport.walking” will be no different than that of the activity “sport.walking companion.dog”. Accordingly, certain characteristics and/or aspects are merely intended to provide further description and/or clarification.

The non-activity linking application 118 is configured to enable non-activities to be associated to the user selected and/or logged activities. Exemplary non-activities include e.g., purchasable items, other events, software applications, digital content, etc. For example, certain purchasable items may be associated to particular ones of activity aspects; then, when the user indicates participation in the activity, purchase of the purchasable items is recommended. Recommendations may take the form of in-application messages, email messages, forwarding the user to a website or webpage, and/or other targeted messaging.

In another embodiment, the non-activity linking application may include features which enable automatic association of metadata tags to non-activities. In yet another embodiment, the non-activity linking application may further enable a user to associate metadata tags to non-activities himself. For example, the user may indicate that a particular blog post concerns a particular activity via the application of a metadata tag thereto as discussed herein.

FIG. 2C demonstrates one exemplary application of the aforementioned uniform metadata tags to non-activities. As shown, e-commerce pages may be tagged with metadata tags; in the given example, a web page featuring a basketball shoe may be tagged as “sport.basketball”; similarly a digital content page relating to a professional basketball player (e.g., Steph Curry) may be tagged as “sport.basketball”. In one embodiment, a plurality of purchasable items and digital content are tagged as illustrated. Then, when the user participates in an activity and logs that participation via the health monitoring application 120, the activity is tagged with metadata tags from the metadata tag library 106 which match to those of the one or more non-activity content. In the illustrated example, the user participates in basketball (“sport.basketball”) and running (“sport.running”). As indicated above, several of the non-activity content is tagged “sport.basketball” therefore, in one embodiment, the “sport.basketball” non-activity content may be recommended to the user in response to the user's logged “sport.basketball” activity. Similar logic applies to other ones of the metadata tags.

In another variant, a threshold level of similarity between the metadata tag of the user's selected activity and the non-activity content is needed in order to provide a recommendation. For example, a user may log an activity which has a metadata tag of “sport.running companion.dog”, in such instance, non-activity content relating to “sport.running” may be determined to have a threshold level of similarity to the logged activity because the identified aspect is the same. Hence, a rule may be derived that non-activity content is only marked by aspect with no supporting characteristics, in this case any logged activity with the same aspect may be within the threshold similarity. Other rules may be derived as well, the foregoing being merely representative of the general concepts of the disclosure.

Referring back to FIG. 1, the system 100 functions to enable an operator having appropriate credentials or authorization to input via the operator interface 112 one or more aspects and/or characteristics to be stored at the metadata tag library 106. In addition, the operator may enter one or more associations at the non-activity linking application 118. Further, the operator at the network server 102 may update and/or modify the algorithms which are implemented at the score calculation application 116 and/or provide associations between particular score values to specific activities.

Exemplary methods of (i) automatically associating metadata tags to one or more activities; (ii) enabling user association of metadata tags to one or more activities; and (iii) associating non-activities to logged activities are discussed in further detail below.

### Methodology

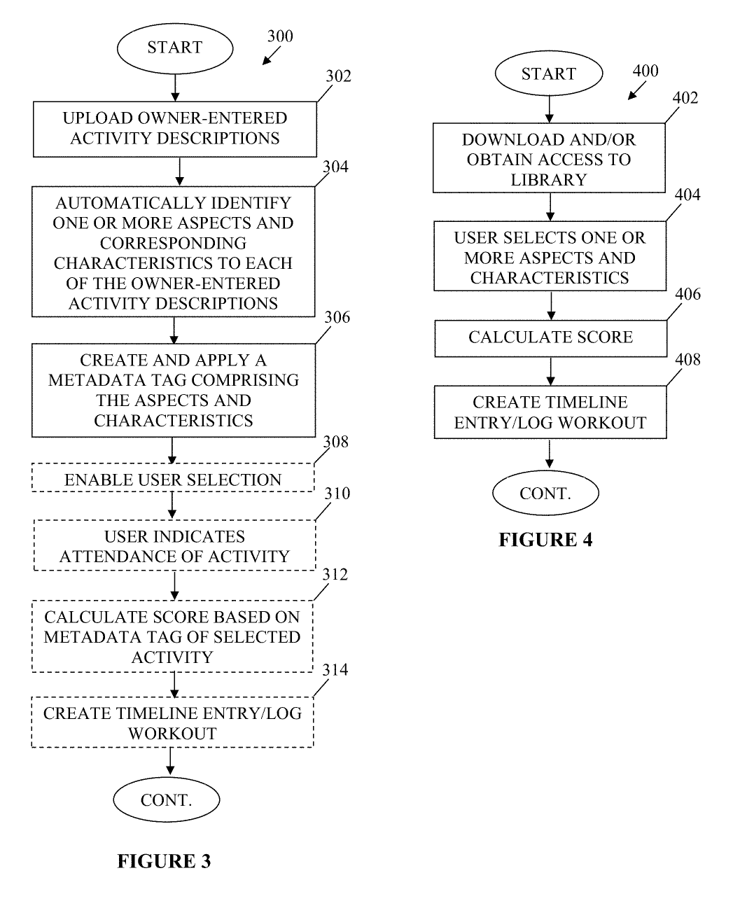

Referring now to FIG. 3, an exemplary method 300 for automatically associating metadata tags to one or more activities is given. As shown, per step 302, a plurality of owner-entered activity descriptions are uploaded. In one embodiment, the owner may comprise an activity provider such as a gym or studio owner or authorized operator thereof (such as a coach, administrator, etc.). In such instances, the owner/operator may enter the activities in the form of a class or training schedule. As discussed elsewhere herein users may later select to join one or more of the classes via the schedule. The entries themselves may comprise text descriptions which are manually entered by the operator/owner into the third party server 108. Alternatively, the entries may be pulled from a previously created document using existing optical character recognition (OCR) technologies at the third party server 108 and/or network server 102.

Next, per step 304, one or more aspects and corresponding characteristics are automatically identified from the metadata library 106 which correspond to the owner-entered activity descriptions and at step 306, the identified aspects/characteristics are then utilized to create and apply a metadata tag (e.g., “sport.running equipment.treadmill”, “sport.basketball objective.practice”, etc.). In one exemplary embodiment, the automatic association comprises utilization of at least one machine learning technique. According to this embodiment, a network-side operator may manually tag one or more activities via tags from the metadata tag library 106 via entry thereof at the operator interface 112, in order to provide a reference from which an application at the network server 102 (such as the metadata tag application 114) may learn to perform the association automatically and without further user/operator intervention. The metadata tag, once created, may be applied to a given activity entry as a separate metadata file, or may comprise inseparable descriptive data. Once the metadata tags are applied to the schedule or list of activities, they are stored at the third party server 108 or other entity in communication with the network 110 (not shown).

It is noted that in one embodiment, the method 300 is completed upon the termination of step 306; the remaining steps (i.e., steps 308-314) are optional.

At step 308, a user is provided with a means for selecting from among the owner-entered activity descriptions. For example, the user may select from a schedule of available classes and/or from a list displayed via the health monitoring application 120. In one specific variant, the health monitoring application 120 may be further configured to display the schedule or list of events entered by the activity provider, then, the user may select from the schedule or list those activities which the user intends to participate.

As noted above, the schedule or list may comprise activities that will occur in the future hence at step 310 the user indicates attendance at the activity. In one embodiment, this step may be performed automatically, that is the health monitoring application 120 or other system entity may set a timer for the date and time the activity which the user selected at step 308 is set to take place. Then, at the scheduled time (or within a reasonable time thereafter, i.e., enough time for the activity to have completed), the system provides a message to the user which enables the user to indicate whether or not he/she participated in the activity. In yet another embodiment, the user may enter his/her attendance manually and/or unprompted.

Based on the user's affirmative selection that he/she has attended the activity, at step 312 a score is calculated. In one variant, the score which is calculated comprises a MET score, however other algorithms and mathematical formulas for deriving a score may be applied with equal success. As noted above, the score is calculated at a score calculation application 116 at the network server 102. Alternatively, the score may be calculated at a similar application running at the user device 104. The score calculation is based on the metadata tag applied to the activity as well as the duration. In one variant, the metadata library 106 further comprises exemplary scores and/or rules for determining a score for each of the metadata tags which may be applied. This information may be accessible or downloadable to the calculation entity (e.g., the server 102 and/or user device 104).

Per step 314, a timeline entry and/or workout log is created based on the activity. A timeline entry may comprise a post to a social media website or application which indicates that the user participated in the activity. The user may modify the post to add pictures, further details, etc.; in some instances the user may further indicate the calculated score for the activity. A workout log may comprise a record created in the health monitoring application 120. The calculated score within the workout log is utilized within the health monitoring application 120 to determine a user's daily activity/exercise. The calculated score may be used to offset the calories consumed by the user in that same day.

Referring now to FIG. 4, a logical flow diagram illustrating an exemplary method 400 for enabling user association of metadata tags to one or more activities is provided. As shown, per step 402, a user obtains access to the metadata library 106. In one variant, the library is downloaded to the user device 104, alternatively the user may access the metadata library 106 via communication between the user device 104 and the library 106 (without downloading the library 106 itself).

Next at step 404, the user selects one or more aspects and characteristics from the library 106 which are descriptive of the activity he/she has participated in. For example, if the user has completed beach volleyball practice, the user will select the aspect “sport.volleyball” and the characteristics “surface.sand” and “objective.practice”. To accomplish the foregoing, in one embodiment, the user may be provided with a first list of aspects once one is selected, a second list of characteristics descriptive of the selected aspect will be provided; the user may select any number of characteristics for a given aspect. The user may then be returned to the aspect list to select any additional aspects which were performed. For example, if, after beach volleyball practice the same user went for a run on the beach, the user would after completion of the entry of the first activity, select the “sport.running” aspect, and further indicate the characteristic “surface.sand”.

Next at step 406, a score for the activity (or activities) is determined. That is, for each of the selected aspects and its associated characteristics, a METS or other score is calculated. In one variant, scoring is simplified such that each aspect and characteristics is associated to a predetermined score value stored at the library 106. Hence, the user's selection of a specific activity and characteristics results in a predetermined score, which is then modified based on the amount of time the user has spent performing the activity, distance, heart rate, and/or other factors. It is further noted that certain characteristics will have no effect on the score of a particular activity. That is, if a user selects “sport.volleyball” to describe their activity, they will be given a same score (provided the time, heart rate, etc. remain the same) as if they selected “sport.volleyball” and “objective.practice”; whereas other characteristics will impact the user's score (such as “surface.sand”).

Finally, at step 408, a timeline entry and/or workout log is created based on the selected metadata aspects/characteristics and in some instances the calculated score. The timeline entry and/or workout log may further comprise generation of an activity record including a metadata tag of the type discussed herein. As noted elsewhere herein, the timeline entry creates a post to be published via a social media site. The workout log includes entry of a record into a series of records relating to the user in the health monitoring application 120. In either instance, the user may elect what content is entered and who may view the entry or log.

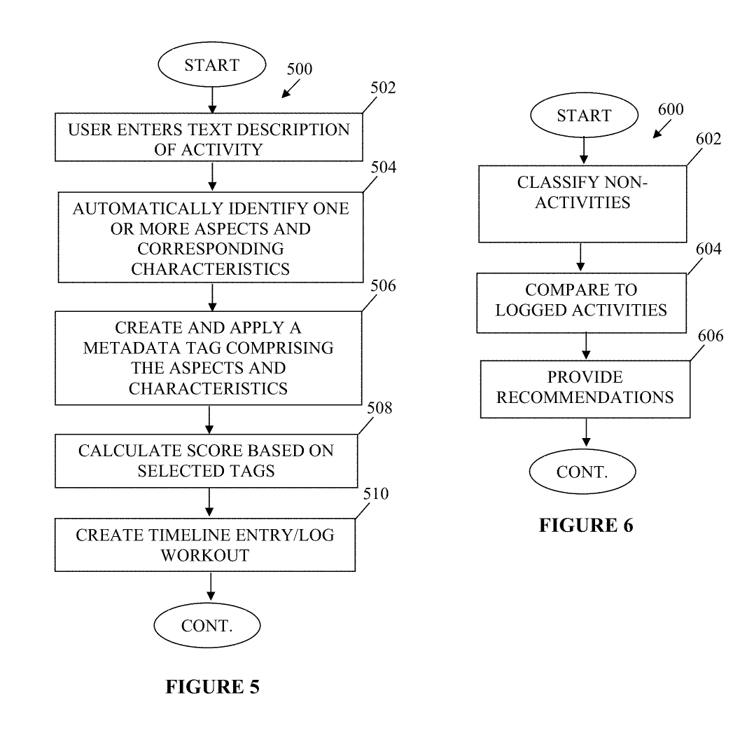

Referring now to FIG. 5, a logical flow diagram illustrating another exemplary method 500 for automatically associating metadata tags to one or more activities is given. As shown, per step 502 the user enters a text description of an activity. The user may enter the description in his/her own words or voice or alternatively may select from a list. The user in this embodiment, comprises a user of the user device 104 who, in one instance, has completed an activity which he/she intends to now enter or log. In another variant, the entry of an activity occurs without user interaction or entry as a monitoring device senses activity. That is to say, in one example, the user need not actively indicate the activity has begun or terminated, rather one or more monitoring devices may determine the type of activity (based on collected or sensed data) and provide the determined activity type as discussed above. For example, a shoe apparatus may comprise a sensor which is configured to determine based on speed, cadence, etc. that a user is running. The data relating to the running workout is then provided to the metadata tag application 114 of the network server 102 as discussed below.

At step 504, the metadata tag application 114 (or similar application running at the user device 104) automatically identifies one or more aspects and a corresponding one or more characteristics for each of the user entered text descriptions. As noted above, the identification of applicable aspects and/or characteristics may occur via the use of one or more machine learning techniques, including machine learning from operator-side manual entry as noted above.

Next, at step 506, a metadata tag is created from the identified aspects and characteristics. The metadata tag may be of the type discussed elsewhere herein (e.g., “sport.running companion.dog”, “sport.hiking surface.trail”, “sport.kickball”, etc.); and is associated to the user entered text description to which it relates. The aspects and characteristics listed in the metadata tag are then used at step 508 to determine a score for participation in the activity. As noted elsewhere herein, the score may be further based on additional factors including e.g., duration, distance, heart rate, etc. and may comprise a MET score, intensity score, or other valuable metric. At step 510 a timeline entry or workout log is created based on the aforementioned metadata tag and in some cases the calculated score. As discussed elsewhere herein, the timeline entry comprises a social media post whereas the workout log comprises a record in the health monitoring application 120 which indicates an offset to the calories consumed by the user within the same 24-hour period.

Finally, with regard to FIG. 6, a logical flow diagram illustrating an exemplary method 600 for associating non-activities to logged activities is provided. As shown, the method 600 begins at step 602, where non-activities are classified according to the previously referenced aspects and corresponding characteristics in the metadata tag library 106. In one embodiment, a metadata tag is created for each of the non-activities to be utilized in a manner similar to that discussed above. Exemplary non-activities may include purchasable items (such as apparel, shoes, etc.), digital content, passes or packages of classes, other events, software applications, and the like. For example, particular web content or pages may be marked with one or more aspects as shown and discussed with regard to FIG. 2C above. The identification of the appropriate aspects and/or characteristics for each non-activity item may be performed by a network operator at the operator interface 112 of the exemplary server 102. Alternatively, or in addition, machine learning techniques may be employed to automate the process of identifying aspects and/or characteristics in order to create metadata tags for non-activities.

Next, at step 604, the metadata tags of the non-activities are compared to the metadata tags of the user's entered activities in order to determine one or more patterns or matches there between. For example, suppose the user has entered activities having the following tags: “sport.running equipment.treadmill”, “sport.basketball objective.practice” and “sport.swimming”). Continuing this example, the comparison of step 604 may yield any number and combination of web pages, digital content, mobile application “cards”, etc. having metadata tags for any of running, basketball and/or swimming.

The identified ones of the non-activities are then recommended per step 606. Thus, following the example above, a web article on swimming tagged as “sport.swimming” may be recommended by providing the content to the user once he/she logs a swimming workout. A link to a web page for basketball shoes may be provided in the instance the user logs a basketball workout as well. Various combinations of activities and non-activity recommendations may be utilized within the context of the present discussion. In addition, patterns may be derived between logged activities of a particular user and those of other users. For example, it may be determined that there is a high correlation between people who log running workouts and those same people logging yoga workouts. Hence, at step 606, content relating to yoga may be provided to a user who enters a running workout.

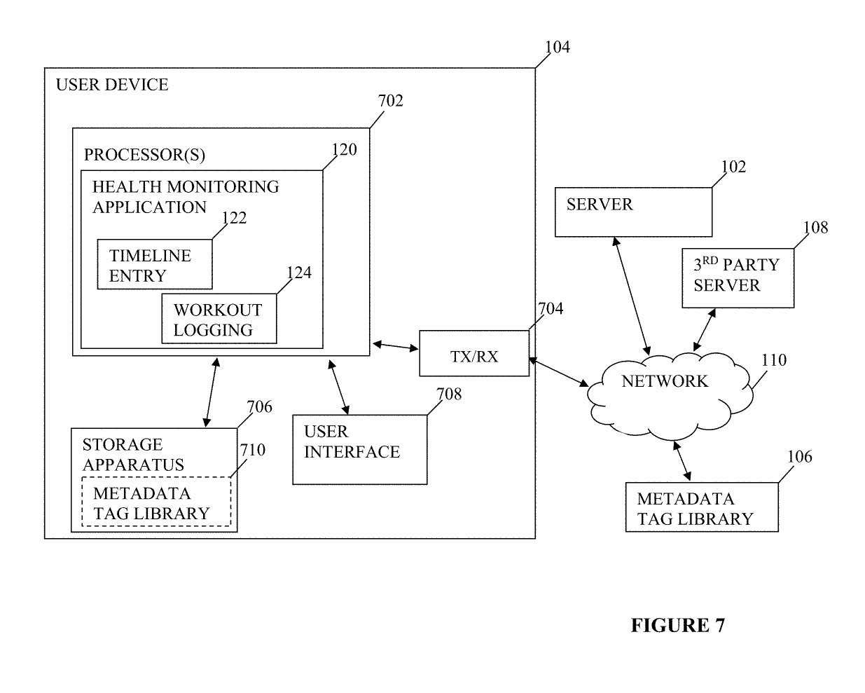

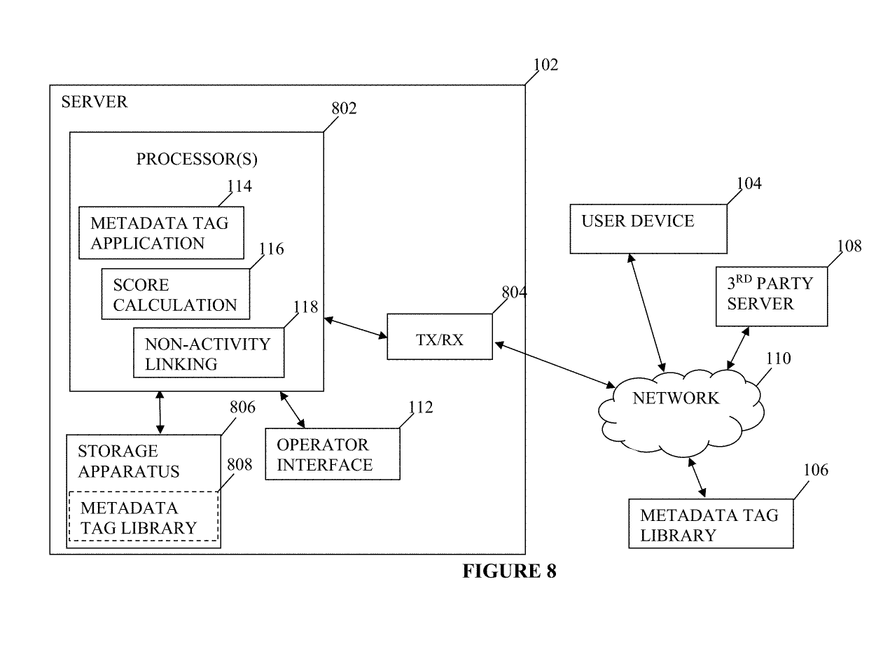

It is noted that the methods 300, 400, 500, 600 of FIGS. 3-6, respectively may be performed at a client or user device 104 and/or at a server apparatus 102. Exemplary apparatus including an exemplary client device 104 and an exemplary network server 102 are now discussed with reference to FIGS. 7-8 below.

### Exemplary User Device

Referring now to FIG. 7, an exemplary user device 104 is provided. The user device 104 may comprise a portable computerized device in one particular embodiment. As illustrated, the device 104 comprises a processor 702, a transceiver 704, a storage device 706, and a user interface 708. As discussed in further detail below, the processor 702 is operable to run at least a health monitoring application 120 thereon.

As noted above, the user device 104 may further comprise a smart phone, smart watch, or other portable electronic device that is configured to monitor user activity (such as via one or more sensors and/or inputs; not shown).

The transceiver 704 of the exemplary user device 104 illustrated in FIG. 7 enables receipt and transmission of communications to and from the user device 104. For example, the transceiver 704 facilitates the transmission of activity data (e.g., text descriptions of activities and/or selections of activities from a provided list) from the user device 104 to the network server 102; the transceiver 704 is also configured to receive metadata tags and/or metadata records (including identified aspects and/or characteristics) from the metadata library 106 and/or the network server 102. In addition, the transceiver 704 facilitates transmission of social media posts (e.g., timeline entries) for publication to a network server 102 and/or other server (not shown) in communication with the network 110. As shown, communication is therefore enabled between the user device 104, the server 102 and the metadata tag library 106 as discussed herein.

The transceiver 704 may be any of various devices configured for communication with other electronic devices, including the ability to send communication signals and receive communication signals. The transceiver 704 may include different types of transceivers configured to communicate with different networks and systems. Such transceivers are well known and will be recognized by those of ordinary skill in the art. In some embodiments, the transceiver 704 includes at least one transceiver configured to allow the user device 104 to perform wireless communications with the cell towers of the wireless telephony network, as will be recognized by those of ordinary skill in the art. The wireless telephony network may comprise any of several known or future network types. For example, the wireless telephony network may comprise commonly used cellular phone networks using CDMA, GSM or FDMA communication schemes, as well as various other current or future wireless telecommunications arrangements. In some embodiments, the transceiver 704 includes at least one transceiver configured to allow the user device 104 to communicate with any of various local area networks using Wi-Fi, Bluetooth® or any of various other communications schemes.

The storage apparatus 706 of the exemplary user device 104 in FIG. 7 is configured to store local copies of e.g., collected activity data (received from e.g. a monitoring devices and/or input by a user), associated metadata tags, a client-side version of the aforementioned computer applications (including in one variant the metadata tag application, score calculation application as well as the illustrated health monitoring application 120), metadata tags, workout logs, social media posts, and/or any other locally created or stored data. In another embodiment, the metadata tag library 106 in whole or in part as well as a schedule of available activities may be stored in whole or in part at the storage apparatus 706.

The processor 702 is configured to execute at least a health monitoring application 120 thereon. The health monitoring application 120 may be downloaded via a network interface from a web-based server, or alternatively be pre-installed on the device 104 at purchase. The health monitoring application 120 comprises a plurality of instructions which are configured to, when executed by the processor 702, enable the device 104 monitor, sense or otherwise obtain data relating to the user's participation in an activity in order to enable uniform tagging thereof as discussed herein. In one specific embodiment, the health monitoring application 120 comprises a plurality of functional applications including a timeline entry application 122 and a workout logging application 124. Additional functional applications which are not illustrated may include, but are not limited to: a library access application, a data collection application, and a display generation application. Each of these will be discussed in turn below.

The timeline entry application 122 comprises a plurality of instructions which are configured to, when executed by the processor 702, enable the creation of social media posts based on activities entered by the user manually, selected by the user from a list or schedule, detected automatically by a sensor associated with the user device 104. The social media post may comprise information relating to the activity including a text description entered by the user, an activity service provider and/or derived from the metadata tag created via a metadata tag application (such as the metadata tag application 114 run at the network server 102 and discussed elsewhere herein). In another variant the social media post may comprise information relating to the calculated score applied to the activity (such as a MET score, intensity score, a so-called “WILLpower” score and so forth).

As discussed above, the timeline entry may be created at the time the user selects a scheduled workout, however, publication of the entry to the user's social media timeline may be delayed until a reasonable time after the workout was scheduled. Accordingly, the timeline entry application 122 may further comprise a timer or time-based trigger function which is created upon user selection of a future workout (such as from a schedule), and may be adjusted according to the duration of the scheduled activity. For example, if the selected activity is set to last one hour and begin at 1 pm, the alarm or alert may be set for 2:15 pm. The alert itself may comprise the text and/or images which are generated as the social media post, the user may then select whether he/she attended the event and/or performed the activity and whether he/she would like the timeline entry to be published. In some variants, the user may further elect which social media sites he/she would like the entry to be published to.

The workout logging application 124 comprises a plurality of instructions which are configured to, when executed by the processor 702, enable activity to be entered into a user's daily logged health measurements. In one variant, a record is created relating to the activity and stored at the user device 104 and displayed in conjunction with the health monitoring application for the user. The record includes a description of the activity (based on the metadata tag) and/or the calculated score in one embodiment. The workout logging application 124 enables the activity to be measured against the other measured health parameters of the user. For example, the user may log food intake, hence the logged workout activity may be used as a measure of offset to the calories consumed. In another embodiment, the workout log may be made public or open to one or more selected viewers upon selection thereof by the user. The workout log application 124 may receive information used to create the workout record from the health monitoring application 120, the metadata tag application 114 (and/or a similar application located at the user device (not shown)), and/or the score calculation application 116 (and/or a similar application located at the user device (not shown)).

As discussed above, the workout log may be created at the time the user selects a scheduled workout, however, inclusion of the record to the user's monitored daily activity may be delayed until a reasonable time after the workout was scheduled. Accordingly, the workout log application 124 may further comprise a timer or time-based trigger function which is created upon user selection of a future workout (such as from a schedule), and may be adjusted according to the duration of the scheduled activity. For example, if the selected activity is set to last one hour and begin at 1 pm, the alarm or alert may be set for 2:15 pm. In response to the alert, the user may select whether he/she attended the event and/or performed the workout/activity and whether he/she would like the workout/activity to be logged.

The library access application comprises a plurality of instructions which are configured to, when executed by the processor 702, enable intra-application and/or intra-device communications to facilitate access to the metadata tag library 106. In one embodiment, the library access application may enable the user device 104 to access the library 106 directly via the network 110. In another embodiment, the library access application may enable access of a portion of the library stored at the user device 104. In either instance, the library access application enables the user device 104 to identify specific ones of the available metadata tags descriptive of the aspects and characteristics of user activities (as discussed above).

The data collection application comprises a plurality of instructions which are configured to, when executed by the processor 702, collect, sense, monitor, and/or otherwise obtain health parameter related data. In one embodiment, the data collection application enables the health monitoring application, such as e.g., UA Record™, MapMyFitness®, MyFitnessPal®, Endomondo®, etc. each owned by assignee hereof, to display health related data. Other health activity related monitoring applications may additionally be utilized as well. It is appreciated that the data collection application may comprise a series of additional components necessary for the separate function of data collection, including e.g., communication components, sensor components, etc. (not shown).

The display generation application comprises a plurality of instructions which are configured to, when executed by the processor 402, enable the generation of a plurality of user interfaces or displays discussed herein. Specifically, one or more user interfaces may be generated which display the aforementioned lists or schedules of activities, display the collected health-related data, display one or more additional web pages, “cards”, digital content, and so forth.

It is appreciated that the user device 104 may comprise additional applications (not shown) which contribute to the functioning thereof as described herein and/or the foregoing functionality may be distributed across more applications or combined into fewer applications. These and other components of the user device 104 will be clear to a person of ordinary skill in the art given the discussion of the functionality herein.

In one embodiment, the aforementioned processing is performed via coordination of a distributed application having client and network-side components. The network-side component may be run at a network entity (such as the server 102) and the client-side component run at the user device 104.

The herein-described applications enable uniform identification of various user activities as discussed throughout the disclosure and include e.g., the health monitoring application 120, the timeline entry application 122, the workout logging application 124, the library access application, the data collection application, and the display generation application. A permanent copy of the programming instructions for these applications may be placed into permanent storage devices (such as e.g., the storage apparatus 706) during manufacture of the user device 104, or in the field, through e.g., a distribution medium (not shown), such as a compact disc (CD), or from a distribution server (not shown) via the network 110. That is, one or more distribution media having an implementation of the agent program may be employed to distribute the agent and program various computing devices.

The herein described applications improve the functioning of the user device 104 by enabling it to collect activity data, and enable the data to be uniformly tagged. Furthermore, devices that are able to provide a means for uniform data tagging as disclosed herein can operate to more effectively enable activity logging across various applications including logging of activities from a third party uploaded schedule or list, enable more accurate score calculation for the logged activities, and provide additional non-activity recommendations.

### Exemplary Sever

Referring now to FIG. 8, an exemplary server device 102 is provided. The server 102 may comprise a computerized device having a processor 802, a transceiver 804, a storage device 806, and an operator interface 112.

The transceiver 804 of the exemplary server 102 illustrated in FIG. 8 enables receipt and transmission of communications to and from the server 102. For example, the transceiver 804 facilitates the transmission of metadata tags (e.g., “sport.running”, “sport.walking equipment.treadmill”, and so forth), calculated scores, recommended activities and so forth to e.g., the user devices 104. The transceiver 804 may also facilitate communications to the server 102 such as from the user devices 104, the metadata tag library 106, the third party server 108, and/or other network devices (not shown).

The operator interface 112 of the exemplary server 102 (illustrated at FIG. 8) comprises an interface which enables an operator having appropriate credentials or authorization to input one or more aspects and/or characteristics to be stored at the metadata tag library 106 or utilized by the metadata tag application 114 (such as to “teach” a machine learning algorithm). In addition, the operator interface 112 may enable the operator to enter one or more associations for the non-activity linking application 118. Further, the operator interface 112 may enable the operator to update and/or modify the algorithms which are implemented at the score calculation application 116 and/or provide associations between particular score values to specific activities.

The storage apparatus 806 of the exemplary server 102 in FIG. 8 is configured to store local copies of e.g., collected activity data (received from e.g. a monitoring devices and/or input by a user), associated metadata tags, the applications run at the processor 802, workout logs, social media posts, and/or any other locally created or stored data. In another embodiment, the metadata tag library 106 in whole or in part as well as a schedule of available activities may be stored in whole or in part at the storage apparatus 806.

The processor 802 is configured to execute one or more applications thereon. The applications may be downloaded via a network interface from a web-based server, or alternatively be pre-installed on the device 102. The applications may include at least a metadata tag application 114, a score calculation application 116, and a non-activity linking application 118. The aforementioned applications comprise a plurality of instructions which are configured to, when executed by the processor 802, facilitate uniform tagging of the activities which in a user performs and/or participates. The metadata tag application 114, the score calculation application 116, and the non-activity linking application 118 will each be discussed in turn below.

The metadata tag application 114 comprises a plurality of instructions which are configured to, when executed by the processor 802, receive a plurality of a user and/or activity provider entered or identified activities. For each of the activities, the metadata tag application 114 identifies one or more aspects and corresponding characteristics from the metadata tag library 106. Finally, the metadata tag application 114 generates a metadata tag from the identified aspects/characteristics. The metadata tag may be stored at the storage apparatus 806 and/or provided to the user devices 104 for storage thereat.

In one embodiment, the metadata tag application 114 is configured to automatically associate metadata tags to one or more activities. According to this embodiment, the application 114 receives text descriptions of the activities entered manually, from a list, via spoken word, and/or via selection from a list of available activities. As indicated, the metadata tag application 114 matches individual words of the text descriptions to various aspect and/or characteristic records in the metadata tag database 106. Matching may occur via utilization of one or more machine learning techniques.

In another embodiment, the metadata tag application 114 is configured to enable user association of metadata tags to one or more activities. According to this embodiment, the application 114 provides a graphical user interface (GUI) which lists activity aspects and associated characteristics from the metadata library 106 for selection by the user and/or the activity provider (as opposed to the selection occurring automatically as discussed above).

The score calculation application 116 comprises a plurality of instructions which are configured to, when executed by the processor 802, utilize the metadata tag to determine a score to be associated to the activity. In one embodiment, a MET score is calculated; alternatively, an intensity score may be calculated. Various other scores may be calculated based on the metadata tag and/or other data collected or sensed at the user device 104.

The non-activity linking application 118 comprises a plurality of instructions which are configured to, when executed by the processor 802, review a plurality of metadata tags associated to one or more activities and a plurality of metadata tags associated to non-activities. The non-activity linking application 118 is further configured to identify one or more non-activities to recommend to a user based on the one or more activities; the identification may then be provided to the user device 104 for display to the user.

It is appreciated that the server 102 may comprise additional applications (not shown) which contribute to the functioning thereof as described herein and/or the foregoing functionality may be distributed across more applications or combined into fewer applications. Including e.g., placement of the metadata tag application 114, the score calculation application 116, and the non-activity linking application 118 at an individual administrator or operator device (not shown). These and other components of the server 102 will be clear to a person of ordinary skill in the art given the discussion of the functionality herein.

The herein-described applications enable association of metadata tags to one or more activities, the metadata tags include one or more aspect identifiers and associated characteristics descriptive thereof as discussed throughout the disclosure and include e.g., the metadata tag application 114, the score calculation application 116, and the non-activity linking application 118. A permanent copy of the programming instructions for these applications (114, 116, and/or 118) may be placed into permanent storage devices (such as e.g., the storage apparatus 806) during manufacture of the server 102, or in the field, through e.g., a distribution medium (not shown), such as a compact disc (CD), or from a distribution server (not shown) via the network 110. That is, one or more distribution media having an implementation of the agent program may be employed to distribute the agent and program various computing devices.

The herein-described applications (114, 116, and/or 118) improve the functioning of the server 102 by enabling it to associate metadata tags to one or more activities thereby enabling uniformity in activity descriptions and score calculation.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

It will be appreciated that the various ones of the foregoing aspects of the present disclosure, or any parts or functions thereof, may be implemented using hardware, software, firmware, tangible, and non-transitory computer readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method of automating categorization of activities, said method comprising:
receiving at a network server one or more text descriptions relating to a respective one or more activities;
said network server using at least one machine learning technique to, for each of said plurality of text descriptions, automatically identify one or more of a plurality of aspects and a corresponding particular one of a plurality of characteristics further descriptive of each of said one or more identified aspects from a library thereof applicable thereto;
for each of said plurality of text descriptions, creating a metadata tag comprising said one or more of said plurality of aspects and said corresponding particular one of said plurality of characteristics; and
associating respective ones of said metadata tags to each of said plurality of text descriptions to which it relates;
wherein each of said plurality of aspects in said library is associated to a unique subset of said plurality of characteristics, said particular one of said plurality of characteristics for each of said one or more of said plurality of aspects being selected from said unique subset associated thereto.

2. The method of claim 1, wherein said one or more text descriptions relating to said respective one or more activities are entered by a respective plurality of provider of activity services and are associated to a schedule of available activities selectable by a user.

3. The method of claim 2, further comprising, upon selection of at least one of said one or more text descriptions relating to said respective one or more activities in said schedule, calculating a metabolic equivalent of task (MET) score thereof.

4. The method of claim 3, further comprising, upon completion of a scheduled time of said selected activity, receiving an indication of participation therein by said user and creating a workout log relating thereto and comprising at least said calculated MET score.

5. The method of claim 3, further comprising, upon completion of a scheduled time of said selected activity, automatically creating a social media post indicating participation of said user in said selected activity.

6. The method of claim 1, wherein said one or more text descriptions relating to said respective one or more activities are entered by a user.

7. The method of claim 6, further comprising:
calculating a metabolic equivalent of task (MET) score for each of said one or more text descriptions relating to said respective one or more activities; and
creating a workout log relating to said one or more text descriptions relating to said respective one or more activities, said log comprising at least said calculated MET score.

8. The method of claim 6, further comprising creating a social media post indicating participation by said user in said one or more text descriptions relating to said respective one or more activities.

9. A non-transitory, computer readable medium comprising a plurality of instructions which are configured to, when executed, cause a user device to:
access a library comprising a plurality of aspects and a corresponding plurality of characteristics further descriptive of each of said plurality of aspects;
select one or more of said plurality of aspects and a respective one or more of said plurality of characteristics to create a metadata tag representative of one or more activities;
calculate a metabolic equivalent of task (MET) score based on said metadata tag relating to said one or more activities; and
create a workout log relating to said one or more activities, said log comprising at least said calculated MET score.

10. The computer readable medium of claim 9, wherein said plurality of instructions are further configured to, when executed, cause said user device to create a social media post indicating participation by said user in said one or more activities.

11. The computer readable medium of claim 9, wherein said plurality of instructions are further configured to access a list of a plurality of non-activity items each being associated to one or more facets, compare said facets of each of said plurality of non-activity items in said list to said metadata tag, and provide a recommendation to said user of individual ones of said non-activity items having a same or similar facet to said one or more aspects of said metadata tag.

12. The computer readable medium of claim 9, wherein said plurality of instructions are further configured to enable a user to enter a text description of said one or more activities, and said selection of said one or more of said plurality of aspects and said respective one or more of said plurality of characteristics occurs automatically.

13. The computer readable medium of claim 9, wherein said one or more of said plurality of aspects comprise one or more of: sport, equipment, and muscle group.

14. A network apparatus configured to enable automated categorization of activities, said apparatus comprising:
one or more interfaces;
a storage apparatus; and
a processor configured to execute at least one computer application thereon, said computer application comprising a plurality of instructions which are configured to, when executed, cause said network apparatus to:
use at least one machine learning technique to, for each of a plurality of entered text descriptions relating to one or more activities, automatically identify one or more of a plurality of aspects and a corresponding particular one of a plurality of characteristics further descriptive of each of said one or more identified aspects from a library thereof applicable thereto;
for each of said plurality of text descriptions, create a metadata tag comprising said one or more of said plurality of aspects and said corresponding particular one of said plurality of characteristics;
associate respective ones of said metadata tags to each of said plurality of text descriptions to which it relates; and
calculate a metabolic equivalent of task (MET) score based on said metadata tags for each of said plurality of text descriptions.

15. The network apparatus of claim 14, wherein said entered text descriptions are received from a user, and said plurality of instructions are further configured to, when executed, cause said network apparatus to automatically create a workout log relating to said one or more activities, said log comprising at least said calculated MET score.

16. The network apparatus of claim 14, wherein said entered text descriptions are received from a provider of said one or more activities, and said plurality of instructions are further configured to, when executed, cause said network apparatus to, when it is determined that user attended said one or more activities, create a workout log relating to said one or more activities, said log comprising at least said calculated MET score.

17. The network apparatus of claim 14, wherein said plurality of aspects and said plurality of characteristics are identified from a remote library; and wherein each of said plurality of aspects in said library is associated to a unique subset of said plurality of characteristics, said particular one of said plurality of characteristics for each of said one or more of said plurality of aspects being selected from said unique subset associated thereto.

18. The network apparatus of claim 14, wherein said plurality of instructions are further configured to, when executed, cause said network apparatus to display a calorie offset based on said MET score of said one or more activities given a food intake of said user.

19. The network apparatus of claim 14, wherein said plurality of instructions are further configured to, when executed, cause said network apparatus to compare metadata tags of non-activity items to said metadata tags, and recommend one or more of said non-activity items based on matches there between.

20. The network apparatus of claim 19, wherein said one or more of said plurality of non-activity items comprises one or more of: purchasable items, software applications, and second activity events.
